(19) United States
(12) Patent Application Publication
(10) Pub. No.: US 2016/0350734 A1
(43) Pub. Date: Dec. 1, 2016

(54) Versatile, Real Time, Two-Ways Payment for Power and Utilities

(71) Applicants: Gideon Samid, Rockville, MD (US); Amnon Samid, Rockville, MD (US)

(72) Inventor: Gideon Samid, Rockville, MD (US)

(21) Appl. No.: 14/726,851

(22) Filed: Jun. 1, 2015

(51) Int. Cl. G06Q 20/14

(52) U.S. Cl. CPC G06Q 20/145; G06Q 50/06

(57) ABSTRACT

Methods and systems providing for versatile, smooth, effective, and secure delivery of power and other utilities based on frictionless payment that exploits the co-emergence of complementary technologies: (i) digital money, and (ii) retail energy generation and trade. Cost effective means provide for (a) pay-as-you-go protocols replacing invoicing, collection, and related court proceedings, (b) allow instant rewards to consumers who use power in a helpful way, (c) provide for retail trade between spot power generators, and near by consumers, and (d) promote trade with “green dollars,” money that bears witness to its positive environmental impact.

### CROSS REFERENCE TO RELATED APPLICATIONS

This application claims as priority date provisional application filed by the same inventors, application No. 62/006,165 filed on Jun. 1, 2014 entitled: “Utility PaySmart GAl”

### BRIEF SUMMARY OF THE INVENTION

This invention is comprised of novel payment options designed to (i) eliminate invoicing, collection, and related court proceedings, (ii) enable the Utility to induce its customers to an advantageous power usage pattern, (iii) accommodate the emerging technologies for spot power generation by allowing power generators and power consumers to trade with power, directly or via the grid, and (iv) exploiting the emerging technology of digital money to promote “green dollars” that bear witness to a positive environmental impact. These payment solutions are convenient, and integrate wearables, smartphones, and other computing device; they are secure and quite effective against cyber threats, and they are versatile, and adaptable to various power consumption patterns around the world.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Power supply and other utilities are essential for our modern civil life. They must be smoothly delivered to be thrifty with our resources, and prudent with their environmental impact. The quality of the delivery of power depends on the active participation of the customer, who may manage and plan his power consumption and even his power generation (new technologies) to help reduce cost and alleviate adverse environmental impact. To lure the customer into a partnership with the utility it is necessary to present a smart payment option that will replace today's tedium of metering, invoicing, and collection, and offer instead a pay-as-you-go power delivery. Moreover the viable solution will allow the power supplier to instantly reward consumers who manage their demand pattern in a helpful way, as well as reward consumers who become power-suppliers themselves. Two emerging technologies are being exploited in this invention: (i) the technology of digital money, and (ii) the technology of spot power generation that may be diverted for sale via the grid. New ideas are needed to put these co-emerging new technologies into an effective and robust solution—that is what this invention is all about.

### Overview

Method and system for processing utilities two way payments including pay-as-you-go payments using money digitization, funds transfer network, behavior management, incentivizing savings and rewarding green energy. A protocol for controlling and managing electricity and other consumables usage behavior and incentivizing savings and rewarding green energy and a framework for eco-system of coalition of users of green-electricity. Converting any utility meter (analogue or digital) to become a two-way payment meter, allowing easy, fast, secured, convenient, inexpensive money transfer between utilities and consumers, requiring no account/credit- card/sending invoices, only a smart phone. It offers more efficient, lower cost and more environmentally sound energy usage and management.

Embodiments of the invention include a method and system for conducting payments (whether real time or post usage or incremental etc.) to and from the consumer's appliance or meter, enabling utilities to easily charge for use or time or time of use based on different tariffs according to time of the day or year and consumption load, without worrying about collection, invoicing etc., from micropayment to macropayments. The same for rebate or remuneration payments from the utilities to the consumer. The method may eliminate the need of the consumer to expose any account or credit or debit card details, although even by deployment of this present invention, a user will be able by choice to continue using its credit or debit card or any other existing payment method. The method further includes transferring and receiving money represented as data between the meter and the utility, between the meter and the consumer's appliance (like smart phone, tablet, laptop, PC, any memory device etc.), between the utility and consumer appliance, between consumer device and merchant device, using the cellular network, or NFC, blue tooth or RFID etc. and between any other device with memory to any other device with memory, and notifying the payer and the payee of the assignment. The invention further includes a small device added to or embedded in any utility meter (mechanical, electro-mechanical, analogue or digital etc.) or any other consumables meter [hereunder: utility meter] to make each utility meter to become a one-way or two-way (or more) payment and rebate and remuneration meter—allowing easy, fast, inexpensive, secured, convenient money (or alike) transfer between utilities or any other consumables' providers and consumers or customers, requiring no account/credit-card/sending invoices, only a smart phone or tablet or alike (with or without NFC chip). It offers more efficient, lower cost and more environmentally sound energy usage and management.

The invention further includes establishing an eco-system of users of utility-digital-money protocol or utility-green-digital-money protocol or electricity-green-digital-money protocol or digitized Green Electricity Initiative protocol or any consumable-green-digital-money protocol [hereunder: green-digital-money or Green Electricity Initiative], that will be virally spread locally or globally and contribute to people's awareness for savings and deeper use of clean or renewable energy. Green-digital-money will be used for shopping and any payment or money transfer off-line and online, while more and more merchants and retailers are supporting and gaining customer's loyalty. Green-digital money is minted from energy or water or gas or any other consumable savings or efficient use or self-production of clean or renewable energy.

One of the purposes of this invention is to cut utility (electricity, water, gas etc.) bills and to enable providing to the consumer rebate or remuneration (whether real time or post usage etc.) due to reduced usage peaks, hence enhancing consumers' and merchants and utilities' cash flow, boost revenue and loyalty. Deploying the invention will enable to convert each existing or future utility meter to an automatic secured and trusted payment and rebate meter. It will enable consumers, among others, to get rebate or remuneration (cash money or digital coupons etc.) to their phones (or tablets etc.) every time when they are satisfying utilities request to reduce demand during peak hours or at any other time, or as a reward for self-production of clean or renewable (like solar, wind) energy. It will enable merchants to encourage saving energy and clean and renewable energy production and to reduce payments processing costs.

Our challenge is to find a solution that could be implemented in a wide variety of properties. As the grid becomes more integrated, the need for a frictionless framework for stable electricity supply from different sources, centralized and de-centralized, fossil and renewable, as well as effectively encouraging savings during peak hours, is more acute. It seems that money has the ‘power’ to control our—individuals as well as utilities/governments—behavior. The Green Electricity money protocol, which is part of this patent, demonstrates these capabilities and will open new dimensions. By properly tethering the digitized electricity money conditional use and redemption, the same protocol will enable utilities to have better control on their cash flow, while consumers will get immediate reward per ‘good behavior’ [e.g. reducing peak demand, self-production of clean or renewable energy] and retailers that join the Green Electricity Initiative will gain reduced financing costs. The number of joining utilities, retailers and individuals is projected to grow exponentially.

Although the present invention is described in relation to particular embodiments thereof, many other variations and other uses will be apparent to those skilled in the art. It is preferred, therefore, that the present invention be limited not by the specific disclosure herein, but by the gist and scope of the disclosure.

### Specification Elements

1. A computer implemented method of providing an anonymous or recognized direct payment from a utility meter located at the consumer's premises or nearby to the utility devices or from mobile or other payer's device to the utility's payee device to enable an electronic payment between a payer and a payee without the need of provision of an account number or credit card/debit card details or payer's name. The method comprising offering a pre-payment suite for enhancing both consumers experience and the utilities cash flow and payments and revenue assurance. The inclusion of the pre-paid suite is non-disruptive for the utility and it does not require replacement of the meter. It eliminates the need of transferring the payment amount from an account associated with the payer to an account associated with the payee, nor need for retrieving the payer information, nor sending bill payment message.

2. The method further comprising enabling real-time payment per exact use. A real-time payment calculator will be determining the rate of bits to be paid for the ongoing electricity consumption, and when the payment is stopped, the system will affect a usage controller to prevent theft. Today most utility are measured, processed, a bill is sent to the consumer and money is later collected. This is a burden that this invention eliminates. No bill, no collection, pay as you go.

3. The method further comprising providing to the power consumers the option to pay their bills with mobile phones, while blue-tooth or near-field communications (NFC) technology or any other communication technology will be used to read the utility meters by the consumer's smart phone/mobile device that then sends the payment (represented as data) via its 2G or 3G or 4G network directly to the utility, without need for a financial back-end to completes the payment.

4. The method include also a small inexpensive digital device—smart payment box—to add to each utility meter (electro-mechanical or digital) that will become a two-way real time payment and rebate meter—allowing easy, fast, inexpensive, secured, convenient money transfer between utilities and consumers, requiring no account/credit-card/sending invoices, only a smart phone. It offers more efficient, lower cost and more environmentally sound energy usage and management.

5. The method further comprising providing to the consumer another option: The consumer fits a digital money device into a payment box linked to the utility meter. Payment is transacted while consuming the paid-for power or any other consumables. No Pay, No Power. Never an Invoice, No collection burden. The Consumer buys the payment device, sticks it into the payment box connected to the power meter for real time payment. Secure electronics insures against all applicable options for fraud and theft of power. Existing prepaid solutions require activation connectivity between the meter and the utility company. Existing prepaid solutions are not interchangeable, are dead-end, while the solution described by this is invention can be readily switched from one meter to the other, and the digital money format positions it toward interception of the digital money economy of the future.

6. The method further comprising providing the consumers who shifts his heavy duty consumption to off peak hours to get paid back through the payment box or through his/her mobile device. Pay-back is instantaneous, visible, creating a powerful incentive to ‘make money’ while helping the utility company and the environment.

7. The method further comprising consumers installing solar energy collectors or wind turbines to be able to seamlessly sell their energy to the utility company. The sold energy is paid for in digital money that can be used to pay for power purchased from the utility company in the future or for any other payment use online or offline.

8. The method further comprising providing a payment from a mobile device to a payee device to enable direct an electronic payment between a payer and a payee without provision of an account number or credit card or debit card or name. It enables, among others, the consumer to transfer payment received from utilities directly to any other mobile device, all or part of it. The method further includes receiving an acknowledgement text message from the payee's mobile to the payer's mobile.

9. The method further comprising providing to the payer an option to determine the terms of use of the payment transferred from his/her mobile device, as well as to split the money hold on the mobile device, to share it among friends, email or text it across the globe.

10. The method further comprising a protocol for establishing a Green Electricity Coalition, that will be based on money received as a reward for saving energy during peak hours or producing clean renewable energy or any other reward decided by the utility. The Green Electricity Coalition protocol, based on digital or virtual cash for on-line as well as off-line use [No need for a designated reader or changes at POS (Point of Sale) at retail touch points], will virally attract individuals, utilities and merchants and retailers to join forces and leverage technology solutions to catapult world power generation industry into the main contributor to the reality of sustainable global prosperity. The same for any other consumable.

### DESCRIPTION

### Description Overview

Method and system for processing utilities two way payments including pay-as-you-go payments using money digitization, behavior management, incentivizing savings and rewarding green energy. A protocol for managing electricity and other consumables usage behavior, rewarding savings and green energy and a framework for eco-system of coalition of users of green-electricity. Converting any utility meter (analogue or digital) to become a payment meter.

### Field of the Invention

The present invention generally relates to behavioral demand response, to how customers and utilities share their electrons and revenues, efficient energy and other consumables usage and electronic payments per time or rate and time and way of use of consumables, and more particularly to systems and methods in which payments or remunerations are being pushed or being pulled based on time-of-use or peak pricing or flat rates or changing tariffs or any other incentives using digitization of money and tethering it to certain terms and conditions.

Motivation:

The home energy management market has made plenty of promises, but has not succeeded to deliver savings, especially during peak hours. There is no solution that is offering household consumers a comprehensive or seamless way to the individual's energy needs. There is no solution that connects the consumer with their own self-production potential. There is no solution that enables the consumer to make their own choices for reducing electricity bill without compromising quality of life. And there is no solution that enables the consumer to partner with the utility to reduce CO2 emissions and fight global warming without jeopardizing compromising their cash flow.

The challenge of finding a balance between utilities, nations and consumers interests as well as between incorporating clean but low cost renewable energy sources without jeopardizing utilities cash flow and financial stability has become ever more acute for the global power sector in recent years. Only lately, are the costs and security, privacy and health implications of smart grid/metering becoming apparent.

We have to do everything in our power to deal with these critical issues, as fast as we can. The digital landscape is creating new opportunities. Money digitization algorithms as well as digitizing KwH streams stands to revolutionize payments, governance, environmental and economic fortunes of individuals, utilities and nations.

Since the inception of electricity deregulation and market-driven pricing throughout the world, utilities have been looking for a means to match consumption with generation. Traditional electricity meters only measure total consumption and as such cannot help consumers better manage their energy use and reduce their energy bills and carbon emissions.

With mandatory energy audits for large companies, there is a growing interest for intelligent energy monitoring by large consumers. However, this kind of solutions does not seem to be effective for household. Giving a home kit that will require opening an Internet portal, or connecting high energy appliances to a dedicated box, will not make life easier. Studies show that there are less than 30% chances that home energy users will use the data presented to change their habits.

There is a high and growing interest by households for reducing the energy bill. This can be achieved by saving energy especially during peak hours, use energy when it is cheapest and by integrating solar/wind energy by self-production, while receiving accurate rebate/remuneration from utilities. Not only will households save money, but also utilities will benefit from the solution as their peak loads will be reduced and they will get closer to meeting their energy efficiency targets.

However, deployments of existing Demand/Response solutions used by businesses and industrial customers that are gathering consumption data, while an agent is actively monitoring and manage consumption 24 hours a day cannot be effective for households.

Households require products and services that are user friendly to the consumer and are contributing to the individual enrichment of the life experience day by day. The digital landscape is creating new opportunities. Our challenge is to find a solution that could be implemented in a wide variety of properties. We'll present here how the Smartphone, which is such a universal device, can connect utilities and consumers in real time, so they become allies in the battle to reduce household bills.

Moreover, a growth in distributed electricity generation from alternative sources such as wind, solar, micro-CHP and bio-gas is anticipated. Home and businesses will both generate and consume electricity. This will result in two-way or even multi-way energy traffic between homes and businesses, and between consumers and energy producers. At the same time there will be changes in the pattern of demand (for example washing machines come on only when the electricity price is at lowest, e.g. when there is a surplus of solar energy). The power industry has to be ready for these developments.

Presently, there are several methods by which a consumer can electronically pay for purchases made on the Internet, such as credit cards, off-line debit cards, online debit cards, digital cash, and smart cards. Each of these methods has its own advantages and disadvantages. An off-line debit card uses the traditional credit card system for clearing the payment but no Personal Identification Number (PIN) is required. The use of an on-line debit card requires that the consumer supply his or her PIN, and the amount of the purchase is debited from the consumer's account instantaneously. One disadvantage with both the on and off-line debit cards, from a consumer's point of view, is the inability to reverse or repudiate the transaction. In contrast, by use of a credit card, the consumer at a later date can reverse the transaction (e.g., if the purchased goods are never shipped to the consumer).

The household electricity demand/response market attracted many mature as well as start-up companies to come up with semi-technological solutions. Basically their promises to significant reduction in home electricity consumption were not materialized. Most of them just provided more detailed or deeper insight of energy usage. Market leader is Opower, with revenue grew from $28.7 million in 2011 to $88.7 million in 2013, which came mostly from subscriptions with Opower's 93 utility customers. Opower claim to save residential utility customers an average 1.5 percent to 2.5 percent on their electricity bill, just by updating them periodically on their electricity consumption relative to their neighbors with similar profile. Opower's competitors are Nest Labs (purchased by Google), Oracle, Aclara, C3 Energy, SAP, and Tendril. Microsoft tried and failed with the Hohm energy platform. Google tried with the Power Meter home energy suite, but abandoned it after acquiring Nest. However, beside Opower, for most companies finding a profitable business model is a real challenge, as most of them don't really change consumer's energy behavior and definitely not contributing to consumers' or utilities' cash flow.

Despite all latest efforts, household electricity consumption was not reduced significantly and definitely not during peak demand.

Smart grids open the way for development and make use of ICT technology to ensure that energy supply and demand remain in constant balance. On the other hand, there are concerns regarding the cost, health, and privacy effects of smart meters. Moreover, most of the developing countries, are not developed enough, hence not ripe for deploying Smart Grid, infrastructure is poor and even Internet connection is not available everywhere. However, these markets are ripe for an affordable, user friendly add-on device to existing meters, that will enable consumers controlling their energy demand and save money;—this is one of the challenges that the present patent is facing.

We all use and pay for power. Even a small improvement in the payment process translates to fortunes of savings. This patent represents a robust saving agenda based on bit sequence money and an echo-system protocol of green electricity. The inventor will profit on account of the serious benefits the patent will generate around the world to utility companies, to individuals, to retailers, to merchandises, to meter manufacturers.

### DESCRIPTION OF THE INVENTION

To date, there is no efficient or effective way for utilities to encourage consumers in general and household in particular to save energy and other consumables during peak demand time. All traditional forms don't use real-time digital exchange of money represented as data directly from utility to consumer. In addition, the high cost of reading the usage/consumption, sending invoices, collecting money, as well as fees per credit or debit cards are cost prohibitive to a significant portion of society.

Human-science—understanding the human behavior—is one of the keys for encouraging consumers to adapt their use to utilities' demands. The challenge is to find out what makes us tick? Many (even if we don't admit)—are having an itching palm . . . hence, instant-real time cash reward is much more effective than delayed rebate.

Payment is a means of communication: motivating people to serve you, acknowledging help, and being acknowledged for what you do for others. That is why the invention presents here a technology solution that will encourage (=reward) individuals to consume less electricity during peak hours. The invention further includes a conceptual behavioral protocols that will encourage individuals, retailers and utilities to join an echo coalition of Green-Electricity, that will be based on ‘Green cash’ for regular use, but that was “minted” by [=received as a reward against] saving energy during peak hours or producing clean or renewable energy. This Green-Electricity digital cash (for on-line as well as off-line use) will virally attract individuals, utilities and merchants to join forces and leverage technology solutions to catapult world power generation industry into the main contributor to the reality of sustainable global prosperity.

Home and industrial utilities are normally metered, and paid in response to a post-usage invoice. This setup is highly inefficient and cumbersome compared to a pay-as-you-go option where no invoice must be prepared, nor mailed, then reviewed, and not eventually paid-up, and collected. The current meters may be replaced with pay-meters that don't admit the utility flow unless it is being paid as it is being consumed. This invention present solutions for how to insure against by-passing the meter, how to insure against payment fraud and how to help indigent consumers.

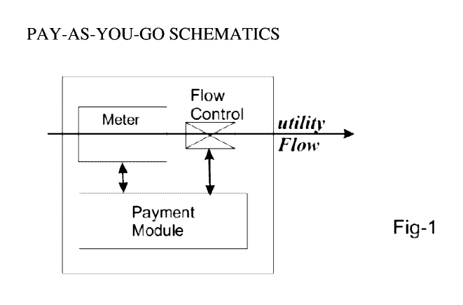

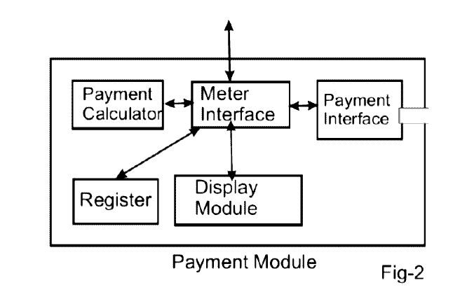

Power supply, in particular, may be a two-way configuration where consumers generated power and wish to push it to the grid. This invention offers a smart pay-as-you-go solution allowing for this configuration. The solution is comprised of a real-time payment apparatus wherein money bits are paid simultaneously with the consumption of the paid utility. It involves a nominal consumption meter for the paid utility, integrated with a payment module and a flow-controller, together referred to as the payment-meter [FIG. 1 and 2].

this invention offers an add-on commodity device, with or without a display, with or without alarm music, which actively controls the electricity payments and income money (remuneration for saving or for producing electricity and/or using electricity stored in batteries and/or clean/renewable electricity sources). Possible position of such a pay smart box is shown in FIG. 7.

Home and businesses will reduce electric bills, save money from day one and control future costs. Utilities are building a ‘greener’ reputation by saving energy, shaving peak loads and encouraging use of clean & renewable energy, while enhancing cash flow.

A protocol for a coalition or eco-system of users of green-digital money, that will be virally spread globally and contribute to people's awareness of energy saving and deeper use of clean energy.

Providing consumers with a user-friendly, safe, fast and reliable way to receive and redeem reward, rebate or remuneration money, by simplifying the current complicated process of reward per saving energy, will enable consumers get their rebate (digitized) loaded directly into their mobile device, phone/tablet/PC or a USB memory stick, whatever they use. Rebate “coins” or green digital money can be readily split, shared among friends, emailed across the globe, ready for making payments with a single tap. Green digital money that is kept in the device (like Phone or PC etc.)—the consumer can easily redeem it by a click of a button—micro or macro payments. No need for a designated reader or changes at POS (Point of Sale) at retail touch points.

Merchants and retailers will be proud to join a coalition of a green echo-system, while lowering the threshold for entry to a reward program, so any Mon-and-Pop store can offer a reward program, allowing consumers to use the green digital money. Consumers will look for retail discounts per usage of green digital money. The appeal is discounted prices at nearby storefronts—and simplicity. The partnership relies on text/SMS messaging. When a consumer comes near a physical storefront connected with that green digital money coalition, a geofence is triggered, prompting an SMS alert to that consumer, which could include a discount offer or reminder of earned rebate money. Moreover: Adding this capability will take the online relationship between utilities to customers into the physical world and will close the circle on the brand-user experience.

Green digital money is stored on the phone (or any other device with memory) for free; can be used and moved—any part of it—in the speed of light through all electronic means: email, SMS, Bluetooth to any other phone or computer, tablet etc., or be used at Eco-Friendly retailers that join the green digital money coalition. The phone is the green digital money bank; On-line/off-line easily switchover.

This invention will change the way consumers are managing and paying for the energy they use. It will offer more efficient, lower cost and more environmentally sound energy usage and management. Beside the contribution to energy efficiency and energy saving and making it easier to deploy alternative energy sources by residential users, it makes sure that utilities as well as the consumers are safe, data protected, generation and supply not be jeopardized by hackers, the environment is not “poisoned” by more and more communication signals, and consumers may get in real time the remuneration against saving energy.

Consumers can monitor their electricity usage and costs in real-time, allowing them to adjust their usage instantaneously in response to changes in prices or system reliability events, or source of energy, for example by delaying the use of a high-energy appliance or shutting it off. This could be done manually or automatically by pre-programming the device or appliance.

Consumers can reduce their demand through time-based rates or other incentive programs. Consumers get more choice in managing their electricity and other consumables consumption, as the payment is directly per-use. Consumers can directly control their billing for use of electricity and other consumables. Consumers can take advantage of different sources of energy (when will be available, solar, wind or fossil fueled), or charging back from car battery, that was charged during off-peak hours, etc. Consumers increases privacy because electricity usage information will not be gathered and not be reported to the utility (the “big brother” syndrome). Consumers can get advantage of technology improvements and lower tariffs without on-site visits by a utility agent.

Outcome of deploying the invention will also be reducing the need to build power plants, or avoiding the use of older, less efficient power plants as consumers lower their electricity demand. Reducing electricity demand at peak hours will reduce the need to build power plants that are necessary only for occasional peak demand (units that are usually very expensive and typically have higher air emissions).

No on-site visits by utility for billing purposes, which results in lower operational costs for the utility.

Not necessarily need always to replace traditional meters or traditional electricity panels and no need for remote energy management.

Eliminate the need to wire specific elements to alternative energy sources inorder to enable different tariffs (feed-in-tariff), while enabling easy and comfort integration of alternative energy sources into the existing infrastructure.

Could be easily incorporated in a Smart Grid, contributing to keeping the grid in balance and improve reliability as consumers will be more cooperative in shaving the peak demands.

By add-on a pay smart box to analogue meters, consumers gain most of the advantages of digital meters, without the need to replace the analogue meters with expensive digital meters; only with a minor add-on of a small box to current meters. Adding such a box, based on this invention, to analogue meters is a less costly compared to digital meters or to traditional interval-time-of-use meters.

The invention is intended to be used on a wide scale with all consumer classes, especially residential consumers, even in the developing countries, where no -infrastructure exist for collecting payments and no Internet access, but only cellular phones.

The invention enables controlling usage of electricity in real-time, unlike the digital meters that at the most have hourly increments.

With current analog meters, it's very inconvenient and actually not practical for consumers to follow their electricity consumption, and with digital meters, users will have to log in to the utility website, However using by using this invention—users can see on the box display or on their phone or tablet display how the money per use is being paid.

Consumers gets automatic alerts (via sound and/or on the box display and/or on their phone or tablet) to notify of when the electricity (or other consumable) consumption exceeds a pre-determined threshold, that will cause higher rate of payment, on one hand, or will reduce amount of income money, for low electricity consumption.

Consumers don't have to register for participating to any time-based rates offered by the utility, as they have the simple and easy opportunity to lower their electricity demand during “peak” periods and potentially save money and even receive money on the spot (not waiting for the next electricity bill or relying on the utility's calculations).

A critical hurdle for implementing existing digital meter systems is the meter data management at the utility, which integrates the smart meter networks with the utility applications, such as billing. Moreover, many times, implementing digital meters for household users requires use of power line communications (PLC) within the home. This invention is free of these two hurdles.

The advanced metering infrastructure that is aimed to replace the analog meters will make it easier to manipulate energy usage data and is introducing new vectors for stilling electricity. Deploying this invention is not vulnerable to those risks.

This invention offers digital-pay-as-you-go per usage, enabling paying at any micro and nano resolution. Consumers (even low consumption consumers like households) will be able to emulate power companies and charge per real time KwH streaming—at different rates for off-peak and on-peak hours, and receiving rebate/remuneration at different rates for savings at peak hours and for producing solar/wind electricity. There exists meters that are based on interval-time-of-use, but this invention enables real-time payment per exact use, using a true electronic cash-equivalent, offering anonymity, versatility, convenience. You need not open an account in some financial institution; your money is not on the cloud, but in your meter or in an add-on box to the meter , or on your mobile device, crypto secure, payment-ready.

A real-time payment calculator will be determining the rate of bits to be paid for the ongoing electricity consumption, and when the payment is stopped, the system will affect a usage controller to prevent theft. Today most utility are measured, processed, a bill is sent to the consumer and money is later collected. This is a burden that this invention eliminates. No bill, no collection, pay as you go.

The display unit will inform the user in real time how he or she are doing—are they in the “green” or are they in the “red”. Are they paying right now too much, so may be the consumption can be reduced. In particular interest is this real time information for electrical power. It makes a big difference what time of the day electricity is consumed. By realizing these differences in real time, the consumer can affect his or her usage pattern in real time.

The electricity consumption (flow) of a utility will be linked in real time to the destruction, burning, erasing, or removing of bits, without the process of redeeming them by a real-time connection to the Mint or to its approval hierarchy. The key to the operation here is to insure that the burnt bits represent money and reflect electricity consumption (validity). The Real-Time Payment Calculator receives as input the rate of electricity consumption of the paid utility and computes the rate of payment. This computation is based on: (i) time of payment, (ii) payment factors, (iii) and the rate formula. The payment factors may be static or dynamic. They may be locally sensed, or may be remotely communicated. Some factors may be downloaded from a central location; others may be communicated interactively from neighboring devices. The payment formula may need the detailed or integrated history of the utility flow. Time may refer to time of day, day of week, day of month, month and year. Electricity should cost more in peak times, and less in off hours. Power may be more expensive in days where the limit is approached, and less in calmer days. Rate may be dependent on the source of power.

Electricity has unique features among nominal utilities: (i) it can't be readily stored, (ii) its cost of production depends on momentary demand, (iii) it supports two-way flow, (iv) it is supplied from various sources at different rates, and (v) it is subject to proactive government incentive programs. All these factors combine to a rather complex payment calculator, depending on a variety of factors. Factors (i,ii,iv) contribute to formula complexity that can be handled by providing the formula data on overall demand over time of use, and of the source of the consumed electricity (Time and Source dependency). This invention provide special attention to the two-way flow option and the government incentives programs.

Electricity can be generated locally by consumers who are also connected to the grid. The locally generated power may be used in lieu of the grid supply, and at time may exceed the supply, and may engender a new back-flow from the consumer to the grid. Such back-flow is necessary because electrical power does not store well. This invention accounts for both the in-lieu mode, and the back-flow mode.

In emerging markets demand for energy is growing rapidly and clean, distributed energy solutions are particularly advantageous. Many of the poorer regions of the world are geographically located in very sunny areas and are very well advantaged for the exploitation of solar energy. Only that they lack the capital for the investment of the facilities that will generate free energy for their use. This difficulty may be handled via long term investors of the kind that invest in toll-roads, pay-tunnels, and communication outlays. Namely, the investor will put up the upfront capital and in turn collect usage fee for a long time to come. But unlike, say a toll bridge, the solar facilities are very many home-based contraptions, and once installed they use free solar energy. This invention deal with the issue of how will the investors make sure that their investment is paid back. Collecting payments is a challenge because many customers lack official identification that would make them formally accountable for a payment liability, and because sending money remotely—without this invention—is a logistically challenging and expensive for people who use cash exclusively. This invention will contribute for making clean (like solar) energy simple, affordable and accessible to everyone, by leveraging advantage of mass adoption of mobile devices, even in undeveloped regions, for boosting profit and efficiencies and for improving distribution and clean energy sources potential to the benefit of customers and utilities.

This invention lends itself to be integrated with the deep-seated digital electronics of metering, and controlling the energy flow. By placing the payment at the IC level, it cannot be plucked out, by-passed, and removed.

Assuming a wide spread deployment of cell-phone towers, and internet, one could build an IP-based payment solution. The consumers will buy bits sticks, latch them into the electronics of the solar energy contraption, and once the Bit stick (wallet) is validated, it sends an activation signal to start consuming and paying for solar energy. The activation will last as long that that latched BitMint stick has remaining bits.

Utilities may wish to connect our home appliances, like many other of the Internet of Things connected devices that will be offered on a service basis where a time used, or resources used will become a basis for payment. This invention enables payment in real time (pay-as-you-go) for all services on the Internet of Things. No invoices, no collection, and no personal database to be hacked. Privacy and efficiency are nicely served.

This invention encourages service providers to install devices, hardware, software, bicycles, tools, data processing, etc, and invest in making such devices available to the public, since the investors will be able to easily charge for their use without worrying about collection, invoicing etc. The installed digital payments may span from micro-payment or macro-payments, and will introduce the blessing of healthy capitalism to the device service market.

This invention enables money to be uploaded to devices and service products such that when they are used the money is paid in real time, through the Internet, and directly to the account of the service provider. Such an easy straight forward pay as you go, cash on the Internet is new and unique.

It is predicted that credit cards will no longer be the dominant on-line point of sale (POS) payment choice. While the green digital money will rapidly be emerging, consumers and merchants will happily conduct a growing volume of commerce using green digital money in favor of the credit and debit as well as pre-paid cards. None of the emerging efforts to date have gotten more than a toehold in the market place and momentum will be built in favor of digital money.

At the present time, there are several large market segments for an online payment system. First, high volume, utility payments (electricity, gas, water etc.); second low (micro as well as nano) payments from consumers to providers of on-line digital intellectual products or services such as written materials, music, software or games as well as off-line payments. A third market segment involves electronic payments from consumers to other consumers. A forth market is foreign remittance payments. Fifth market segment resides in business to business electronic payments or off-line payments. All those will be happy to use green digital money.

Number of installments of electricity meters is expected to grow exponentially, worldwide. Also, retail consumer sales as well as business to business sales on the Internet are projected to grow exponentially. Credit cards are not widely available in Asia and Africa and by foreigners all over the globe. Moreover, using green digital money will provide customers and merchants with a higher degree of surety of payment and receipt as well as lower costs. Moreover, traditionally, consumers use credit cards for larger purchases and definitely not for micro-payments or pay-as-you-go payments. Green digital money can fulfil the need. In some places debit cards have entered the market and have been used as cash and check replacements for lower-volume transactions for purchases of consumable, products such as food and gasoline, but they still require a bank account and verifying the payer and the card. Green digital money will be used like real cash for these payments.

Green digital money is not dependent on the Electronic Funds Transfer [EFT] network, like debit and credit card transactions. Green digital money will not have to be dependent on transaction to be carried over the EFT network from the point of Sale (POS) to a financial institution, unlike traditional debit or credit that pulls money from the user's bank account using the EFT network and subsequently makes payments using conventional means such as the ACH network or paper checks.

processing fees of green digital money will be much lower than the relatively high cost of using credit or debit card, as high fees support the credit card business model. Credit and debit cards are not economically viable for purchases of lower cost items. The green digital money is a low cost process, partly because the payee is not required to bear the burden and risk of authentication. The green digital money is “backed” by the utility who issued it.

The world is moving towards a direct model in which manufacturers of products or services are able to deal directly with consumers and not via intermediates, like credit or debit card issuers. By eliminating the middleman, the direct model is resulting in intense price competition, with manufacturers having much tighter margins. This competition creates the need to minimize all costs especially payment processing costs. Moreover, the trend is to enable large numbers of independent producers to have access to large numbers of consumers on the Internet and get paid directly, cash like. Also: intellectual products such as publications, music, video, software, games are more efficiently distributed digitally over the Internet rather than through traditional physical (paper or disc) media and it is expected to increase significantly, once a pay-as-you-go solution will pop up. All the above trends require low cost to the consumer and to the merchants, the ability to purchase individual works per time or use (song, video, article, game). These characteristics call for a payment form like this invention is offering, that has the ability for macro, micro and nano payments, on line or offline, real-time payments with payment security for both payer and payee. All of these factors serve to encourage a growing number of people to be comfortable with and using this invention.

Furthermore, the high cost of retail wire transfers (i.e., Western Union) is cost prohibitive to a significant portion of society. This invention will reduce significantly these high costs.

Automated Clearing House (ACH) payments have begun to be used with respect to payments made via the Internet, also for utility payments in a few regions. However, unlike this invention, ACH authentication requires a pre-existing relationship between the customer and the merchant, hence ACH payments are not and will not be widely deployed to on-line POS. Furthermore, ACH transactions requires that the user provide the payee) with the “keys” to the user's account. This model raises serious security concerns (fraud etc.), that this invention is eliminating.

Most Electronic Wallets in use today are primarily a method of storing account number or credit card information and other form filling functions (e.g., shipping addresses), in contrast to storing green digital money, that like traditional wallets, provides the user with a form of cash, that is secure and guaranteed and easy for use. Moreover, research indicates that most e-commerce purchases are abandoned at the POS due to consumers' unwillingness to complete lengthy forms or provide personal credit card numbers. Using green digital money eliminates this need.

Deploying green digital money does not suffer from the following drawbacks that characterize most existing models for Internet payments: one—the consumer is required to provide the merchant with his or her account details; two—a pre-existing relationship between the consumer and the merchant is required. With this invention consumers will be released from feel insecure or uneasy about providing their account details to strangers over the Internet. Some of these drawbacks also apply to utility payments.

the invention allows consumers and merchants to conduct secure and economical shopping online and off-line, to pay anyone directly, cash like. The invention furthermore solves many of the problems and drawbacks of the prior art described above, especially users don't have to provide their own sensitive account information. The invention provides an enhanced level of convenience and security because sensitive financial information is not carried over the Internet. Furthermore, payee can rest assured that the payer's money is “good”. The invention provides significant economic advantages over the prior art systems and methods. The majority of the technology required to implement the present invention already exists, which results in reduced startup costs for an institution practicing the present invention.

The invention is not limited to the case of a consumer utility payments. The methods has further, broader applicability by providing the ability for anyone with no account to transfer green digital money to anyone else who also does not have an account.

### Conclusion

The invention represents a new paradigm for utility payments and rebate, that leverages existing platforms, conventional payment infrastructures and currently available utility meters to enable pay-per-use and rebate per savings and remunerate per self-production of clean or renewable energy and enables establishing a coalition of contributors of CO2 reduction in both the virtual and physical marketplace. The concept provides a safe, sound, and secure method that allows users (consumers) to pay exactly per use, to get remuneration directly to their mobile device against savings or clean or renewable energy self-production, using that rebate or remuneration money to shop on the Internet, pay bills, and pay anyone on-line or off-line anywhere, all without the consumer having to share account number or credit cards information with the payee. Merchants receive electronic cash that could be validated immediately, so they can ship their product with confidence and they don't have to pay credit cards fees. The present invention further enables nano, micro or macro payments, pay-as-you-go, pay-per-use pay-per-time, as well as provides effective incentives for savings at peak hours and self-production.

The invention includes an add-on box/device/chip to every utility meter, for any household consumer, as well as industry, tourism, commerce, transportation, public and other customers, it means that billions of low-cost commodity devices will be placed all around the globe.

The home energy management market has made plenty of promises, but has not succeeded to deliver savings, especially during peak hours. There is no one that is offering household consumers a comprehensive or seamless solution to the individual's energy needs. There is no one that connects the consumer with their own self-production potential. There is no one that enables the consumer to make their own choices for reducing electricity bill without jeopardizing quality of life. And there is no one that enables the consumer to partner with the utility to reduce CO2 emissions and fight global warming without compromising their lifestyle. The need for the above—exists; the incentive—exists; this invention offers a smart, reliable, safe, affordable and sustainable solution to fulfill that need. The consumer does not have to compromise its ability to enjoy a modern lifestyle. Utilities have an opportunity to offer value added services to consumers, while enhancing cash balance. Nations gain CO2 reduction and easy deployment of clean renewable energies.

### DRAWINGS

### Brief Description of the Drawings

FIG. 1 Pay-As-You-Go Schematics: depicts a first embodiment of the payment module, the Smart Pay box for Utility Payment Solution, comprised of a nominal consumption meter for the paid utility, integrated with a payment module and a flow-controller, together referred to as the payment-meter.

FIG. 2 Payment Module: depicts an enhanced version of the payment module of real-time payment calculator, a meter interface, a payment interface, and optionally a payment display unit and payment register.

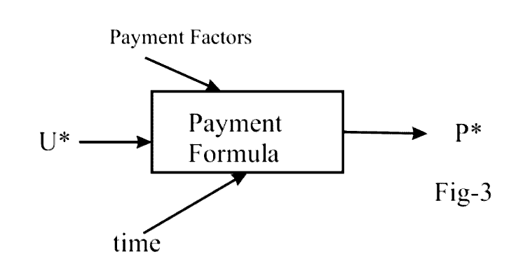

FIG. 3 Payment Formula: depicts a Real-Time Payment Calculator that receives as input the rate of consumption of the paid utility and computes the rate of payment. This computation is based on time of payment, payment factors and the rate formula.

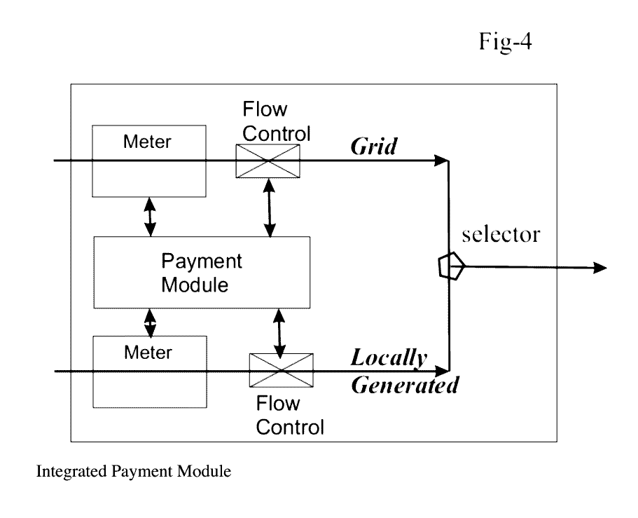

FIG. 4 Integrated Payment Module: illustrates a two-way utility payment module. The meter-payment system includes a two way supply: the grid and the local supply. It includes also a selector that would give preference to the locally generated power ahead of the grid. The locally generated power may be free of charge or charged at a different rate. The payment module will compute the payment for each source.

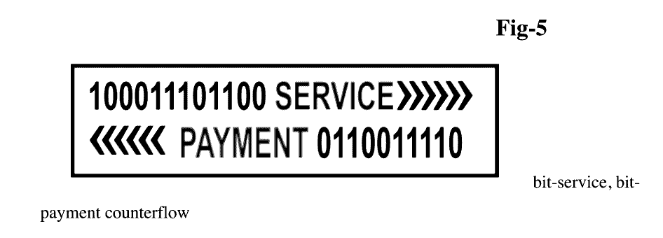

FIG. 5 bit-service, bit-payment counterflow: illustrates a pay-as-you-go for bit-carried utility, where the utility bits flow in opposite direction to the payment bits.

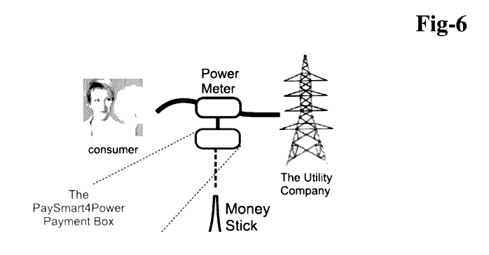

FIG. 6 PaySmart for Power Payment Box: illustrates a possible location and functionality of the PaySmart Box, positioned between the digital money stick and the power meter, so it can drain the money stick commensurate with the power consumtion indicated by the meter.

What is claimed is:

1. a method and a system where payment in a form of bit flow, where the bits represent digital money, is effected real-time to reflect the measure of power or other utilities consumed by the payer.

2. the claim in (1) where the digital money bits are “burnt” to effect the payment, rather than being sent to the payee, and where new bits must be pre-purchased, then burnt to pay for more power, or other utility.

3. the claim in (1) where the digital money bits comprise generic money, and the paid bits are being sent via an electronic network for collection and then redemption by the payee.

4. the claim in (1) where the power supplier may reward well behaving consumers with bit money, marked as “green” since it is a reward for helping the environment, and which is conveniently instantly available to the rewarded consumers via his or her smartphone, smart watch, or other intimate device.

5. the claim as in (1) where the pre-paid bit money is stored in a latch-able, bit-drainable device attached to the power meter with circuitry effecting the real-time pay.

6. the claim as in (1) where the local payment device will feature computing power to carry out payment related computation accounting for real time power consumption, in the surrounding area, accounting for time of the day, day of the year, weather report etc. where all relevant factors are affecting the payment rate.

7. the claim in (1) where the payee is either a consumer rewarded for helpful demand pattern, or a private power generator selling power, or another utility to either the Utility or to neighboring consumer.
